(19) United States
(12) Patent Application Publication
(10) Pub. No.: US 2010/0011350 A1
(43) Pub. Date: Jan. 14, 2010

(54) Method And System For Managing An Initial Boot Image In An Information Storage Device

(76) Inventor: Fernando A. Zayas, Loveland, CO (US)

Correspondence Address: PATTERSON & SHERIDAN, L.L.P., 3040 POST OAK BOULEVARD, SUITE 1500, HOUSTON, TX, 77056, US

(21) Appl. No.: 12/172,976

(22) Filed: Jul. 14, 2008

(51) Int. Cl. G06F 9/445; G06F 9/44; H04L 9/32

(52) U.S. Cl. 717/171; 726/19; 717/168; 717/174

(57) ABSTRACT

A storage device configured with a user-addressable LBA space stores an initial boot image in a region of the LBA space that is outside the user-addressable LBA space. Updates to the initial image are carried out as an unencrypted process when speed is desired. A second copy of the initial boot image may be maintained by the storage device to provide for update flexibility. When two copies of the initial boot image are maintained, one is designated as active and the other is used for updates. When an update to a copy is completed, that copy is designated as being active.

### BACKGROUND OF THE INVENTION

1. Field of the Invention

Embodiments of the present invention relate generally to information storage devices and, more particularly, to a method and system for managing an initial boot image in an information storage device.

2. Description of the Related Art

Information storage devices, such as hard disk drives of laptop and desktop computers, expose their physical media to connected host systems as logical blocks numbered from 0 to some maximum value. The address that is used to access a logical block is known as a logical block address (LBA). When a host system issues a read or a write, it specifies the LBA and the length of the data that is being read or written.

In a conventional hard disk drive, a data structure is stored at LBA=0 and this data structure is used as a pointer to operating system files stored in the hard disk drive. Thus, when a host system is powered on, it reads the data structure at LBA=0 and loads the operating system files from the location specified by this pointer into the host's system memory.

In encryption-enabled hard disk drives, data that would normally be available in the bottom of the LBA space, e.g., LBA=0 to LBA=128 MB, is replaced by an initial boot image that is needed for operating various encryption-related devices, such as biometric input devices and smart card readers, that are offered by a number of different vendors. This image is commonly referred to as “shadow-MBR” (shorthand for “shadow-Master Boot Record”). After the shadow MBR is loaded, the hard disk drive performs authentication of the user. After user authentication, it restores access to the original contents of the bottom space of the LBA, and the host system completes its boot process.

Updating the shadow-MBR is carried out using an encrypted read/write protocol known in the art as Trusted Send/Receive. A user who wants to update the shadow-MBR would begin the process by sending new data for the portion of the shadow-MBR to be rewritten, and then end the process by commanding the hard disk drive to overwrite the portion of the shadow-MBR with the new data.

### SUMMARY OF THE INVENTION

Embodiments of the invention provide an improved method and system for managing the shadow-MBR. According to one embodiment, updating the shadow-MBR is carried out using an unencrypted process, such as with standard ATA read/write commands, so as to improve the speed of updates. According to another embodiment, two copies of the shadow-MBR are maintained. One of the copies is designated as being active, and the other copy is used for updates. When an update to one copy is completed, the updated copy is designated as being active.

A method for installing an initial boot image onto a storage device configured to receive and process encrypted data and unencrypted data from a host, according to an embodiment of the invention, includes the steps of receiving the initial boot image as unencrypted data from the host, and executing a data write operation on the initial boot image. The data write operation comprises a multi-block data write operation, such as an ATA data write operation. In addition, the location of the initial boot image in the storage device is randomly selected by the host and lies outside a normal user-addressable LBA space of the storage device.

A method of updating an initial boot image, according to an embodiment of the invention, includes the steps of receiving an update to the initial boot image, and updating one of at least two copies of the initial boot image using the received update. In addition, when the update to one of the copies of the initial boot image has completed, that copy is designated as the active initial boot image. The updates may be received as encrypted data or as unencrypted data.

A storage device according to an embodiment of the invention is configured with a user-addressable LBA space and has at least two copies of an initial boot image stored in a region of the LBA space that is outside the user-addressable LBA space. The storage device further includes a controller that is programmed to designate one of the copies as an active copy. The controller is programmed to also read the active copy of the initial boot image from a designated region within the user-addressable LBA space and, upon completion thereof, load operating system files using this same region within the user-addressable LBA space.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic block diagram of a host platform and an information storage device in which one or more embodiments of the invention may be implemented.

FIG. 2 is a block diagram illustrating an embodiment of the hard disk drive in FIG. 1.

FIG. 3 is a block diagram schematically illustrating components of a printed circuit board from FIG. 2.

FIG. 4 is a block diagram schematically illustrating components of the system on chip from FIG. 3.

FIG. 5A illustrates a user-addressable LBA space according to the prior art.

FIG. 5B illustrates a user-addressable LBA space according to one or more embodiments of the invention.

FIG. 6 is a flow diagram that illustrates a method of installing an initial boot image in a storage device, according to an embodiment of the invention.

FIG. 7 is a flow diagram that illustrates a method of updating one copy of an initial boot image in a storage device while another copy of an initial boot image is in use, according to an embodiment of the invention.

FIG. 8 is a flow diagram that illustrates a normal boot process of a host and a connected storage device.

For clarity, identical reference numbers have been used, where applicable, to designate identical elements that are common between figures. It is contemplated that features of one embodiment may be incorporated in other embodiments without further recitation.

### DETAILED DESCRIPTION

Embodiments of the invention contemplate a method and system for managing an initial boot image, known as a shadow-MBR, stored in a storage device. According to one embodiment, updating of the shadow-MBR is carried out using an unencrypted process, such as using standard ATA read/write commands, so as to improve the speed of updates. According to another embodiment, two copies of the shadow-MBR are maintained. One of the copies is designated as being active, and the other copy is used for updates. When an update to one copy is completed, the updated copy is designated as being active. Information storage devices that may benefit from embodiments of the invention include hard disk drives (HDDs) of laptop and desktop computers, optical storage devices, solid state storage devices, and magnetic media, among others.

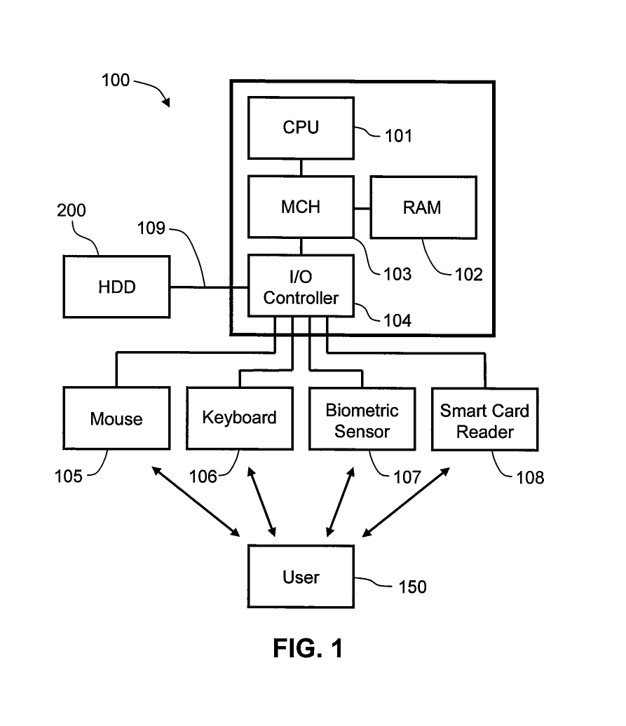

FIG. 1 is a schematic block diagram of a host platform 100 and an information storage device, HDD 200, in which one or more embodiments of the invention may be implemented. Host platform 100 may be a laptop computer, a desktop computer, or an appliance such as set-top boxes, televisions and video players, requesting access to one or more sectors of HDD 200. Alternatively, host platform 100 may be a remote computing device that accesses HDD 200 over a LAN or WAN.

In one embodiment, host platform 100 includes a central processing unit (CPU) 101, RAM 102, a memory controller hub (MCH) 103, an I/O controller hub 104, a plurality of I/O devices 105-108, and a communications link 109 with HDD 200. Host platform 100 also includes an operating system, the software component of host platform 100 that manages and coordinates operation of the hardware making up host platform 100, and provides a user interface to host platform 100. The operating system typically resides in RAM 102 during operation of host platform 100. When host platform 100 is part of a network, the operating system may be downloaded from network storage upon boot-up of host platform 100. When host platform 100 is contained in a stand-alone computer, such as a laptop or desktop, the operating system is loaded into RAM 102 from HDD 200 or other local storage medium that is part of the stand-alone computer.

CPU 101 is a processor that executes the software programs run on host platform 100. RAM 102 provides the data storage as required for the operation of CPU 101 and host platform 100. Memory controller hub 103 routes communications between CPU 101, RAM 102, I/O controller hub 104, and any graphics hardware that may be included in host platform 100, such as a graphics card. I/O controller hub 104 provides an interface with host platform 100 for I/O devices, and routes and controls data to and from the I/O devices. As illustrated in FIG. 1, host platform 100 includes a plurality of I/O devices, including HDD 200, a mouse 105, a keyboard 106, a biometric sensor 107, and a smart card reader 108. Mouse 105 and keyboard 106 provide user 150 with conventional computer interfaces to host platform 100, allowing input by user 150 of user credentials, such as user ID number and alphanumeric passwords and access codes. Biometric sensor 107 allows entry of a user biometric credential into host platform 100. For example, biometric sensor 107 may be a fingerprint scanner for entry of a user fingerprint. Other examples of biometric credentials include face, hand, and iris geometry. Smart card reader 108 is configured to accept and read a smart card, which is a pocket-sized or credit card-sized card with an embedded integrated circuit that includes an encrypted access code.

Host platform 100 is connected to HDD 200 via communications link 109. When host platform 100 is contained in a stand-alone computer, communications link 109 represents an internal bus connecting HDD 200 to CPU 101 via I/O controller hub 104. When host platform 100 is part of a network, communications link 109 includes the network connections between host platform 100 and HDD 200. In one embodiment, HDD 200 is contained in the computing device making up host platform 100, such as a laptop or desktop computer. In another embodiment, HDD 200 is physically separated from host platform 100 and is accessed remotely via a network connection established by host platform 100.

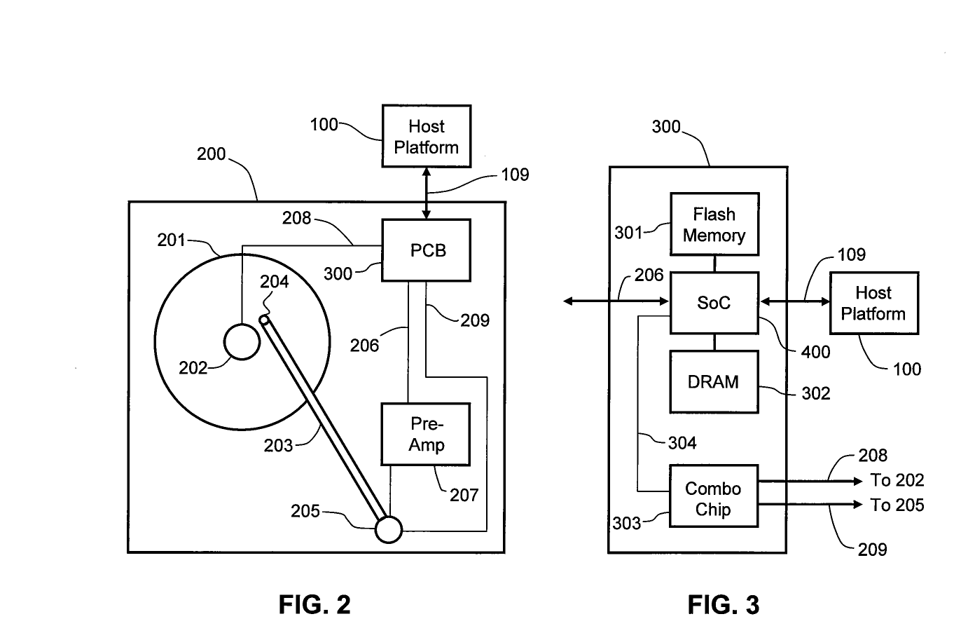

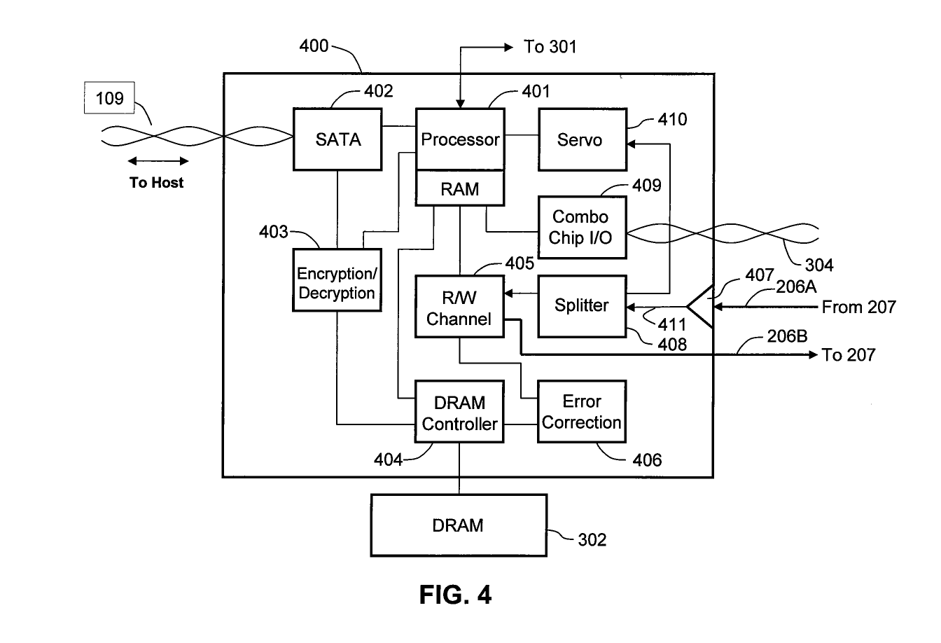

FIG. 2 is a block diagram illustrating an embodiment of HDD 200, in FIG. 1. The mechanical components of HDD 200 include a magnetic disk 201 rotated by a spindle motor 202 and a read/write head 204 disposed on the end of a suspension arm 203. Arm actuator 205 is coupled to suspension arm 203 for moving arm 203 as desired to access different tracks of magnetic disk 201. Electronic components of HDD 200 include a printed circuit board, PCB 300, and a pre-amplifier 207, the latter of which is electrically coupled to read/write head 204. Pre-amplifier 207 conditions and amplifies signals to and from read/write head 204. PCB 300 includes a system-on-chip (SoC), RAM, and other integrated circuits for operating HDD 200, and is described below in conjunction with FIGS. 3 and 4. As shown, PCB 300 is electrically coupled to pre-amplifier 207 via electrical connection 206, to spindle motor 202 via electrical connection 208, and to arm actuator 205 via electrical connection 209. PCB 300 communicates with host platform 100 via communications link 109, which may be an SATA, PATA, SCSI, or other interface cable.

FIG. 3 is a block diagram schematically illustrating components of PCB 300 from FIG. 2. PCB 300 includes an SoC 400, DRAM 302, which may be internal or external to SoC 400, flash memory 301, and a combo chip 303, which drives spindle motor 202 and arm actuator 205. Combo chip 303 also includes voltage regulators for SoC 400, pre-amplifier 207, and the motor controllers contained in SoC 400. As shown, flash memory 301 and DRAM 302 are coupled to SoC 400, which interfaces with host platform 100 via communication link 109, pre-amplifier 207 via electrical connection 206, and combo chip 303 via serial bus 304. In some embodiments, flash memory 301 resides in SoC 400. Firmware for HDD 200 resides in flash memory 301. In alternative configurations, a small portion of the firmware that is not changeable resides in a read-only memory within SoC 400 and the bulk of the firmware resides on magnetic disk 201 and loaded shortly after power up.

FIG. 4 is a block diagram schematically illustrating components of SoC 400 from FIG. 3. SoC 400 is an application-specific integrated circuit (ASIC) configured to perform the control and encryption/decryption operations necessary for HDD 200 to provide secure user access based on periodic re-authentication, to securely download firmware, and to store encrypted data on magnetic disk 201. SoC 400 includes a number of functional blocks designed to perform particular functions. Processor 401 is a microcontroller configured to control the operation of HDD 200 and includes RAM and input/output functionality for communication with the other functional blocks of SoC 400, as shown. In one embodiment, processor 401 may be configured with flash memory 301 internally, rather than positioned nearby on PCB 300. SATA block 402 is an input/output block contained in SoC 400 that sends and receives signals to and from host platform 100 via communications link 109. Combo chip I/O block 409 is an I/O block dedicated to communication between processor 401 and combo chip 303 via serial bus 304. Processor 401 is also configured to encrypt data traffic between HDD 200 and host platform 100, particularly security-related traffic, such as encryption keys. Processor 401 and/or block 403 encrypts traffic leaving HDD 200 and being transmitted to host platform 100. Host platform 100 must then decrypt such data using the appropriate encryption key before the encrypted data traffic is useable by host platform 100. Traffic is likewise encrypted from host platform 100 to HDD 200. The movement of encrypted control traffic between HDD 200 and host platform 100 uses “trusted send/trusted receive” commands.

Encryption/decryption block 403, which is under the control of processor 401, is positioned in the data path between SATA block 402 and all other components of SoC 400 to encrypt incoming data for secure storage and decrypt outgoing data for use by host platform 100. That is, encryption/decryption block 403 receives and encrypts input data from host platform 100 via SATA block 402, and decrypts and transmits output data, i.e., data accessed from HDD 200, to host platform 100 via SATA block 402. Encryption/decryption block 403 includes state machines that implement the desired encryption algorithms as well as memory for holding encryption keys and for buffering data during encryption/decryption of data traffic. In operation, encryption/decryption block 403 receives data from host platform 100 in unencrypted form. If appropriate encryption keys are provided for use with the incoming data, said data is encrypted by encryption/decryption block 403 and stored, either in DRAM 302 or on magnetic disk 201. When host platform 100 retrieves stored data, encryption/decryption block 403 decrypts the data prior to transmission by SATA block 402, so that the host receives unencrypted data.

DRAM controller 404 refreshes DRAM 302 and arbitrates the use of DRAM 302, making DRAM 302 accessible to encryption/decryption block 403, processor 401, read/write channel 405, and error correcting and generating block 406, as needed for the proper operation of HDD 200. DRAM 302 serves as a DRAM buffer for data being written to or read from magnetic disk 201 and for data received from host platform 100 after encryption. DRAM 302 may be external to SoC 400 as shown, or, alternatively, may make up one of the functional blocks contained therein. For error-free retrieval of data from magnetic disk 201, error correction block 406 applies error correction to data read from magnetic disk 201 before the data is buffered in DRAM 302 for decryption and transmission to host platform 100. In addition, when data is being written to magnetic disk 201, error correction block 406 appends information to said data to allow error correction upon retrieval of the data from magnetic disk 201.

In order for host platform 100 to retrieve data from magnetic disk 201, data is read from magnetic disk 201 by read/write head 204, conditioned by pre-amplifier 207, and carried as an analog signal by electrical connection 206A to analog-to-digital converter 407. Analog-to-digital converter 407 converts the analog signal to a digital signal 411, which is transmitted to a splitter block 408. From digital signal 411, splitter block 408 sends the appropriate servo-related data to servo block 410 for optimal control of spindle motor 202 and arm actuator 203 using motor 205. Splitter block 408 sends the data requested by host platform 100 to read/write channel 405, which routes the data through error correction block 406 to DRAM 302 for buffering until said data can be decrypted and transmitted to host platform 100.

For storage of data on magnetic disk 201 by host platform 100, encrypted data is buffered in DRAM 302 as necessary and routed through error correction block 406 and then to read/write channel 405. Read/write channel 405 then sends a digital signal via electrical connection 206B to pre-amplifier 207, which conditions and amplifies the digital signal for read/write head 204 to write the encrypted data onto magnetic disk 201. One of skill in the art will appreciate that encrypted data resides in the storage media contained in HDD 200, Le., DRAM 302 and magnetic disk 201.

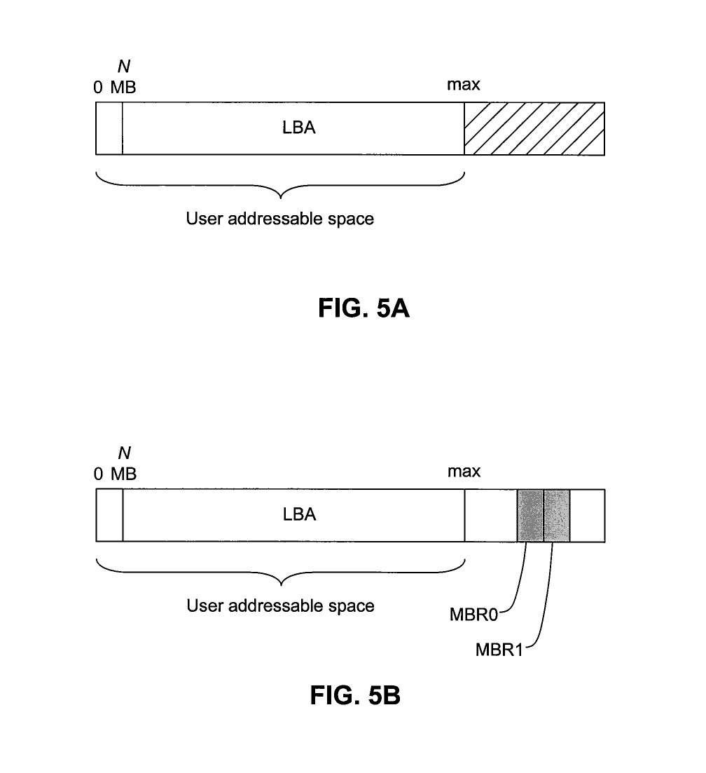

HDD 200 exposes its physical media as logical blocks numbered from 0 to some maximum value. Each logical block is mapped to a corresponding block (defined by track and sector numbers) on the physical media, and processor 401 of HDD 200 maintains such a map of logical blocks to physical blocks. As illustrated in FIG. 5A, a user-addressable LBA space extends from LBA=0 to some maximum value, LBA=max. In conventional full disk encryption hard disk drives, the first N (e.g., 128) MB of the LBA space is reserved for the master boot record, and the hashed region of the LBA space that is beyond LBA=max is not accessible.

In the embodiments of the invention, the region of the LBA space shown in FIG. 5B that is beyond LBA=max is made accessible to reads and writes under certain conditions. Within this region, two copies of the shadow-MBR, MBR0 and MBR1, are stored. One copy of the shadow-MBR is made active and the other copy is used to receive updates.

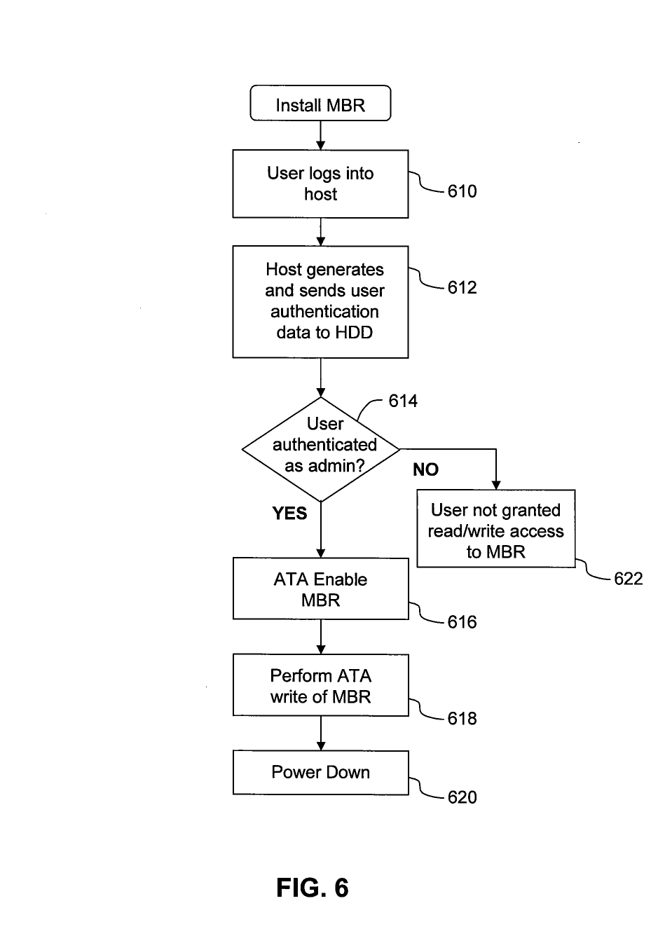

FIG. 6 is a flow diagram that illustrates a method of installing a shadow-MBR or initial boot image (hereinafter referred to as “MBR”) in a storage device, according to an embodiment of the invention. In step 610, a user logs into a host connected to the storage device. The user logs into the host by providing one or more user credentials to the host, in combination with a corresponding user identification name or number. User credentials for this purpose may include an alphanumeric access code, one or more biometric credentials, such as a fingerprint scan, or a properly encoded smart card, among others. For added security, the entry of a combination of user credentials may be required for each successful login. After successful user login, flow proceeds to step 612.

In step 612, the host generates user authentication data for use in authenticating the user at the storage device and sends the user authentication data to the storage device. The host generates the user authentication data using the information that it stored as it was setting up different users for the storage device.

Step 614 is carried out by the storage device, where it determines whether the user is authenticated as an administrator who can modify the MBR using the user authentication data it received from the host. User authentication may be carried out using the methods described in co-pending U.S. patent application Ser. No. 12/060,182, entitled “Storage Device and Encryption Method,” filed Mar. 31, 2008.

If the user is authenticated as an administrator who can modify the MBR, steps 616-620 are carried out. If the user is not authenticated as an administrator who can modify the MBR, the user is not granted read/write access to the MBR (step 622).

In step 616, the ata_enable_mbr function is executed. The ata_enable_mbr function allows read/write access to the MBRs using standard ATA read/write commands. It is recommended that this function be used only in a secure location using local access, not network access, to the storage device. This setting is volatile. At the next loss of context, the MBRs are no longer accessible via ATA read/write commands. The MBRs are made available at a base_LBA value. The base_LBA value is greater than the highest LBA of the user-addressable LBA space (i.e., greater than LBA=max) and less than 2^{M}−1 minus the size of the two MBRs (where M=48 for an ATA interface). In one embodiment, MBR0 is available at the base_LBA and MBR1 is available at the base_LBA plus the size of one MBR copy. In one embodiment, the host specifies base_LBA in a random manner, so that the MBRs are stored in random locations within the user-addressable LBA space greater than LBA=max.

In step 618, an ATA write operation is carried out at the LBA location specified by the host. For a first time installation of MBR, this location is equal to the base_LBA as specified by the host. For updates to an existing MBR, the ATA write operation is performed to overwrite a copy of the MBR that is currently not active. After the update, the user may command the storage device to switch the roles of the two MBRs, so that the one that was just updated becomes the active MBR and the other is used for a subsequent update. The ATA write operation is performed on unencrypted data received from the host and this allows very rapid writing of the MBR. Once the installation is complete, the storage device is powered down (step 620).

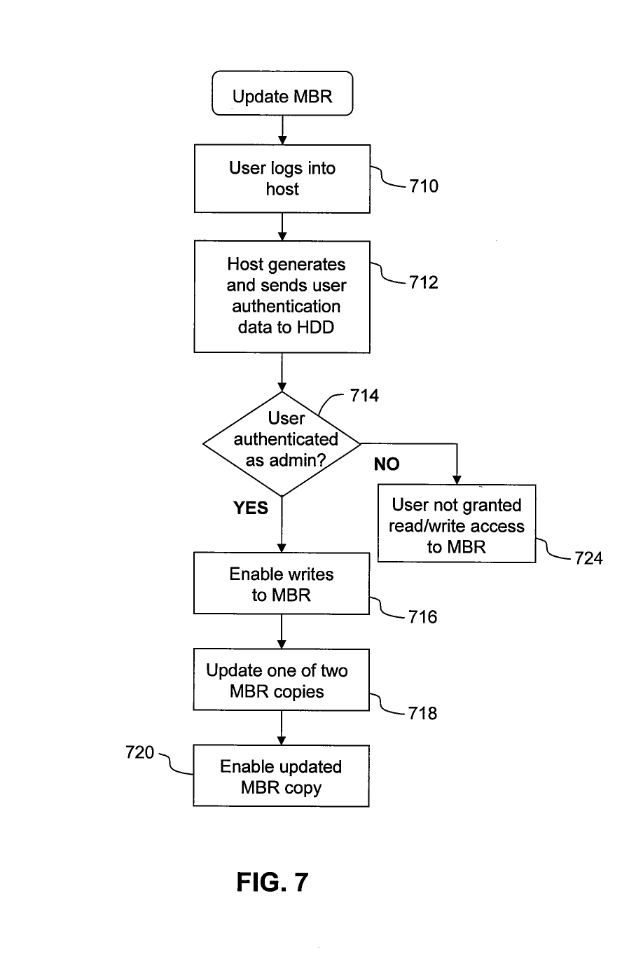

FIG. 7 is a flow diagram that illustrates a method of updating one copy of MBR in a storage device while another copy of MBR is in use, according to an embodiment of the invention. Steps 710-714 are carried out in the similar manner as steps 610-614 described above.

If the user is authenticated as an administrator who can modify the MBR, steps 716-720 are carried out. If the user is not authenticated as an administrator who can modify the MBR, the user is not granted read/write access to the MBR (step 724).

In step 716, writes to MBRs are enabled using a write_mbr function. The write_mbr function allows the MBRs to be written. Then, in step 718, the user updates a copy of the MBR that is not in use. The update may be a partial write of just the updated portions or overwrite of the entire MBR. Afterwards, in step 720, the updated copy of the MBR is designated as the active MBR using the enable_mbr function. The enable_mbr function enables one of the two MBRs to replace the first 128 MB portion of the user-addressable LBA space at power-on time. A flag setting of 0 enables MBR0 and a flag setting of 1 enables MBR1. When either MBR0 or MBR1 has been enabled, the enabled MBR replaces the first 128 MB portion of the LBA space again on the next power-on of the storage device.

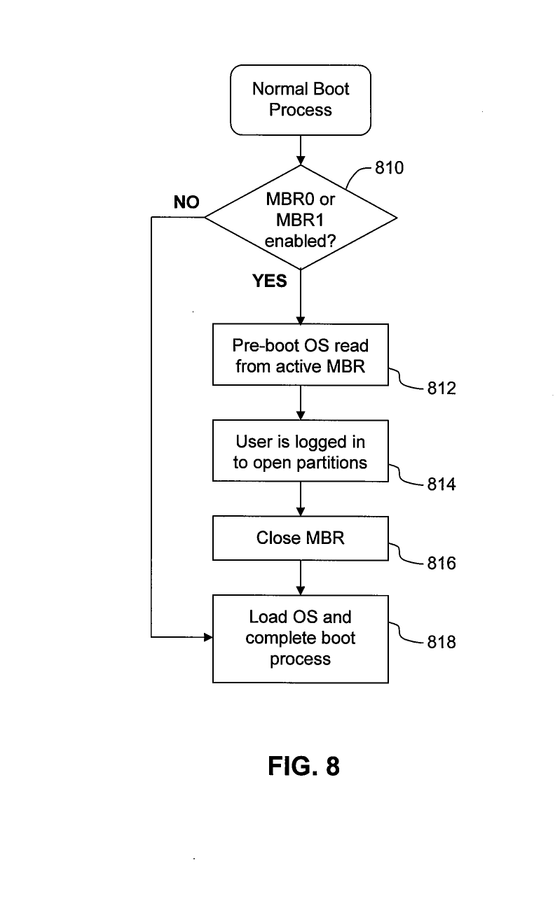

FIG. 8 is a flow diagram that illustrates a normal boot process of a host and a connected storage device. In step 810, the storage device checks to see if either MBR0 or MBR1 has been enabled. The enable_mbr function enables one of the two MBRs to replace the first portion of user LBA space at power-on time. When the MBR replaces the first portion of user LBA space, it is of fixed length and read-only. The close_mbr function disables the MBR. If the MBR is enabled, the MBR replaces the LBA space again on the next power-on.

If either MBR0 or MBR1 has been enabled, steps 812-816 are executed. If not, step 818 is executed. In step 818, the operating system is loaded using the first portion of the LBA space and the boot process is completed.

In step 812, the enabled MBR is read from the first portion of the LBA space and the pre-boot operating system executes from the enabled MBR to authenticate a user. Then, in step 814, the user is logged in to “open” locked partitions on the storage device. Afterwards, the active MBR is closed in step 816 so that the active MBR no longer replaces the first portion of the user LBA space. Step 818, as described above, is executed after step 816.

If a user desires to change a very small portion of the MBR or the updates to the MBR are transmitted over a network, the user could use the method of FIG. 7 and perform writes to the MBR using an encrypted read/write protocol known in the art as Trusted Send/Receive.

While the foregoing is directed to embodiments of the present invention, other and further embodiments of the invention may be devised without departing from the basic scope thereof, and the scope thereof is determined by the claims that follow.

What is claimed is:

1. In a storage device configured to receive and process encrypted data and unencrypted data from a host, a method for installing an initial boot image, comprising:
receiving the initial boot image as unencrypted data from the host; and
executing a data write operation on the initial boot image.

2. The method according to claim 1, wherein the data write operation comprises a multi-block data write operation.

3. The method according to claim 2, wherein the data write operation comprises an ATA data write operation.

4. The method according to claim 1, wherein the step of executing includes:
enabling writes to a region of a logical block address (LBA) space of the storage device that is outside a user-addressable LBA space; and
writing the initial boot image into the region.

5. The method according to claim 4, wherein the region is specified by the host and is randomly selected by the host.

6. The method according to claim 1, further comprising:
receiving user credentials from the host; and
authorizing updates to the initial boot image based on the user credentials.

7. The method according to claim 6, wherein the user credentials are transmitted using an encryption protocol.

8. In a storage device configured to maintain first and second copies of an initial boot image, said one of the copies being designated as an active copy of the initial boot image, a method of updating the initial boot image comprising:
receiving an update to the initial boot image; and
updating one of the copies of the initial boot image using the received update.

9. The method according to claim 8, further comprising: when the update to said one of the copies of the initial boot image has completed, designating said copy as the active initial boot image.

10. The method according to claim 9, wherein the update is received as encrypted data.

11. The method according to claim 10, wherein the update is received as part of a trusted send/receive command.

12. The method according to claim 11, wherein the update is received over a network connection.

13. The method according to claim 9, wherein the update is received as unencrypted data.

14. The method according to claim 8, wherein the step of updating includes:
enabling writes to a region of a logical block address (LBA) space of the storage device that is outside a user-addressable LBA space; and
writing the update into the region.

15. A storage device configured with a user-addressable logical block address (LBA) space, comprising:
a first copy of an initial boot image stored in a region of the LBA space that is outside the user-addressable LBA space; and
a second copy of an initial boot image stored in a region of the LBA space that is outside the user-addressable LBA space.

16. The storage device according to claim 15, further comprising:
a controller that is programmed to designate one of the first copy and the second copy as an active copy.

17. The storage device according to claim 16, wherein the controller is further programmed to update a non-active one of the first copy and the second copy and, after the update, designate the non-active one as the active copy.

18. The storage device according to claim 17, wherein the controller is further programmed to decrypt an update to the initial boot image that has been received in an encrypted form.

19. The storage device according to claim 16, wherein the controller is further programmed to carry out an ATA write operation on an initial boot image that has been received in an unencrypted form.

20. The storage device according to claim 16, wherein the controller is further programmed to read the active copy of the initial boot image from a designated region within the user-addressable LBA space and, upon completion thereof, to load operating system files using said designated region within the user-addressable LBA space.
